(19) United States
(12) Patent Application Publication
(10) Pub. No.: US 2017/0290440 A1
(43) Pub. Date: Oct. 12, 2017

(54) Safety Bed Cover

(71) Applicant: David Haynes, Webster, MA (US)

(72) Inventor: David Haynes, Webster, MA (US)

(21) Appl. No.: 14/835,233

(22) Filed: Aug. 25, 2015

(51) Int. Cl. A47C 31/10; A61G 7/05; A47G 9/02

(52) U.S. Cl. CPC A47C 31/105; A47G 9/0238; A61G 7/052; A47G 2400/12

(57) ABSTRACT

A cover for beds includes a cover with a structural profiles formed by perimeter or otherwise rail aspects such as a top rail aspect, bottom rail aspect, lateral rail aspects, geometrically designed to create desired profiles and/or profiles that form its shape and design. Rails aspects may be made from plastic, foam and/or the like that change the shape and the design can be arranged to achieve desired functional objectives and may be designed to fit hospital bed, any mattress or child mattress. The cover is complemented by a material that may be removed, replaced and/or added to another material.

### FIELD OF THE INVENTION

The present invention relates to medical or otherwise bed covers, and used preferably for covering beds and the like. More particularly, it relates to an improved bed covering that keeps both the bed covering itself and bed occupant safely in place and provides a physical barrier preventing bed occupant excursion including rolling off the bed. Unlike any other bed covering, this bed cover is designed with integrated variations of perimeter rails integrally secured to one of more of the cover's borders providing flexibility of multiple uses utilizing its unique ability to inhibit excursion off the bed, and therefore facilitating protection while keeping the bed occupant comfortable and safe.

### BACKGROUND OF THE INVENTION

Covers for Beds, sometimes also known as sheets, are popular medical bed applications. However, improvements to such covers are still possible and this invention will be able to be modified and customized to fit all mattress sizes from including but not limited to hospital beds, baby cribs and no hospital mattresses.

It is commonly accepted that it may become necessary, for various reasons, to use an apparatus for preventing a bed occupant from falling off the bed during hospitalization or when safety is a concern. For example, if a person is hospitalized and is not restrained, they may fall off their bed, and possibly sustaining additional injuries. Further, occupants with diverse medical issues cannot negotiate safe bed movement i.e., changing resting positions and in these cases the possibility of falling off the bed is a avoidable event.

Typically, hospital beds have been designed with utilization of bed rails, which have limitations. Namely, the aesthetic value is not visually appealing. Also, existing bed rails are difficult to install and remove by some infirmed individuals without the assistance of others. Lastly, it is possible for a bed occupant to further injure themselves as the enter or exit a bed utilizing bed rails.

U.S. Pat. No. 4,653,131 to Diehl (1987), titled Bed Sheet Restraint, does not meet the requirements for in home use by a self-functioning individual. This restraint needs to be attached to the bed by a second individual after a person is lying in bed, and it renders the reclining individual helpless to exit the bed when necessary.

Likewise, U.S. Pat. No. 5,623,950 to Bergeron (1997), titled Security Cover, is also an inferior product. This restraint is “made of a flexible and sturdy material such as canvas, tarpaulin, or the like”. This material is heavy, hot, hard to manipulate, hard to wash, and would not be conducive to providing a clean, cool, and comfortable sleeping environment.

Additionally, this cover has attached snap hooks that attach to a “flexible line” so that the cover can be slid up and down. Since material used for this flexible line is not specified, one may conclude that after much use, this flexible line may become frayed, brittle, or sharp, thus causing the line to break, snap, or cause injury, such as cutting the skin. Also, there is a risk of injury if an individual's arms or legs get caught in the openings that exist between the cover and the bed frame. According to this patent, a second person is needed to finally secure the security cover in place. There is therefore clearly a need for an improved apparatus for preventing a bed occupant from falling off the bed.

### SUMMARY OF THE INVENTION

In view of the foregoing, it is an object of the present invention to provide an improved cover for medical related beddings. The cover for medical environment bedding may be used in any other place or system as well as comprise the most varied kinds of materials in conjunction or separately such as conventional mattress materials which may be rigid and/or flexible materials and/or the like without deviating from the invention since the characteristics originally claimed herein are not lost.

This model may contain other devices added thereto without deviating from the nature of the invention since the characteristics originally claimed herein are not lost.

There are no similar devices of this nature in the state of the art.

The novel bed cover for medical or therapeutic applications, subject matter of this patent, will be described in a clear, concise, and objective manner so that it can be clearly understood and put into practice by any specialist in this technological sector. Based on a set of illustrative drawings, the proposed model is presented by way of example and without an intention to limit the scope of the protection by the patent and only for more detailed analysis of the characteristics to be claimed.

This model, however, must not be limited to the presented form and other configurational conceptions may be considered since they contain the same distinctive functional characteristics of the basic model. This model may also be constructed in a manner that may be cleaned and reused or disposable.

### BRIEF DESCRIPTION OF THE DRAWINGS

FIG. 1 is a perspective view of a cover for beds, according to an embodiment of the present invention, including perimeter rail aspects, a top rail aspect, bottom rail aspect, lateral rail aspects, and a partial perimeter rail aspect;

FIG. 2 is a partially exploded perspective view of the cover of FIG. 1, also including perimeter aspects;

FIG. 3 is a perspective view of the cover of FIG. 1, with the perimeter rail aspects arranged in one of many arrangements on the bed cover;

FIG. 4 is a view of a cover for beds, according to another embodiment of the present invention, including geometrically shaped perimeter rail aspects, a top rail aspect, a bottom rail aspect, and lateral side rail aspects.

### DETAILED DESCRIPTION OF PREFERRED EMBODIMENTS

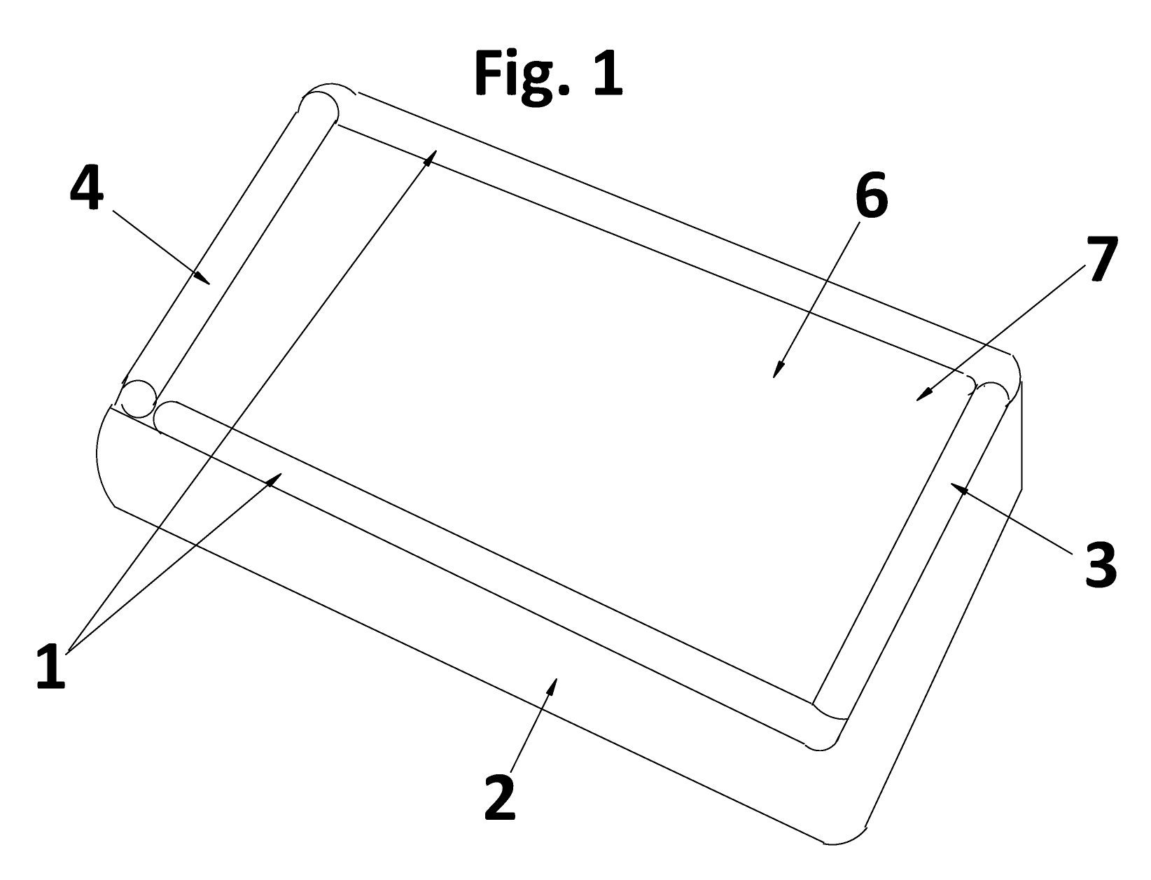

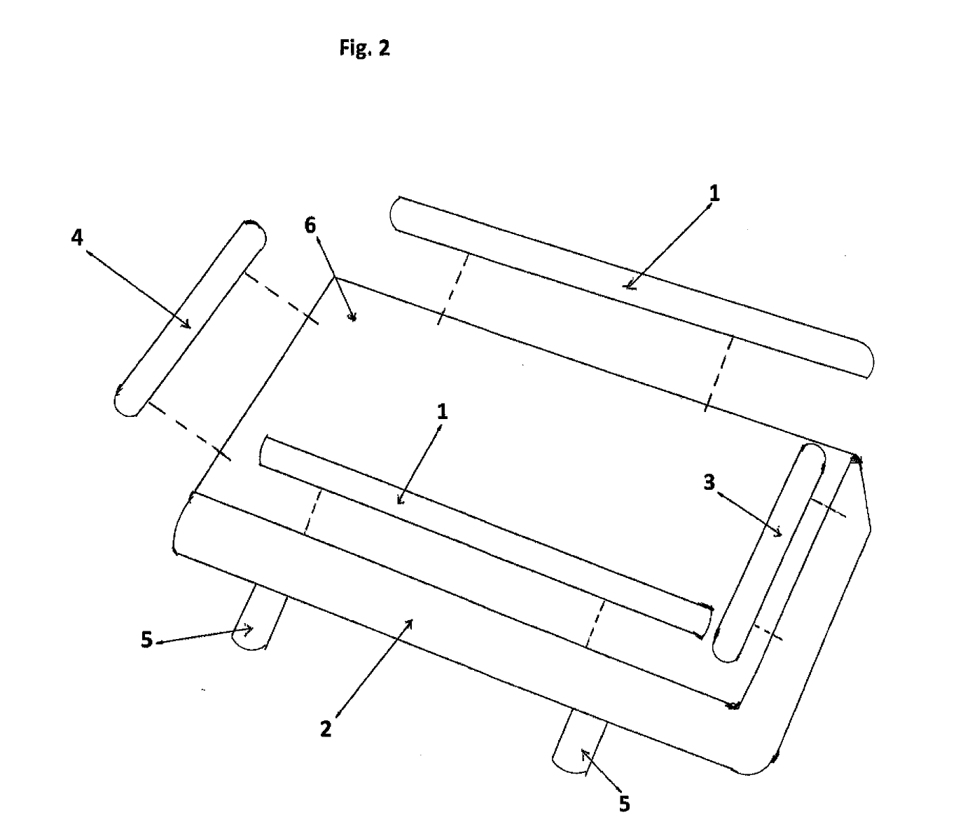

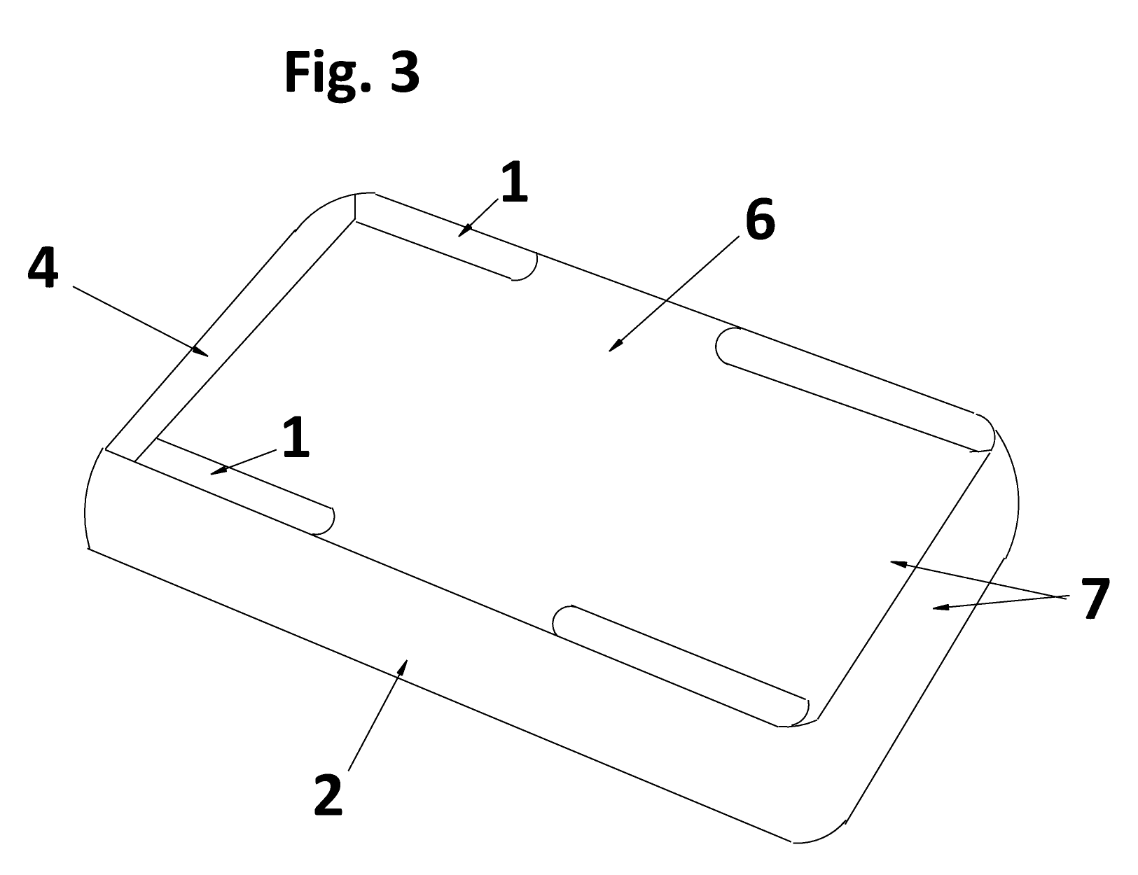

Referring to FIGS. 1-3, the cover for beds, subject matter hereof, is developed and projected from a cover with a structure formed with a top surface 6 and in this illustrated embodiment, side faces 2 collectively referred to as base cover 7 and by perimeter rails 1, 3, and 4 respectively to form , profiles and/or the like, which, in addition to forming various embodiments of the profile of the cover, form its desired shape and design as per the needs and desire of the user. The side lateral rails land bottom rail 3 is formed by various uses of the perimeter rails creating combinations of various profiles from the various geometrically shaped and sized perimeter rail options and/or the like, and has in the top aspect a formed rail 4 and/or the like, which contains the whole top portion with lateral rails 1 creating supports for joining, the bottom aspects 3 that may be secured by means of the perimeter rail(s) 1 creating various profiles and/or the like.

The base cover aspect 7 is made from a flexible and surface conforming material formed aspect and/or the like, and may be made with various materials including; foam, a plurality of blended synthetic plys, cotton, and the like. Base cover 7 is designed to create multiple profiles and/or a formed, aspect or the like that acting as barrier along the bottom aspect of the base cover aspect 7; base cover 7 is complemented by having either removable or fixed embodiment options, and/or the like, perimeter rails 1, 3, and 4, respectively and/or like removable fixed aspects. Base cover 7 can be designed to conform to various mattress shaped surfaces.

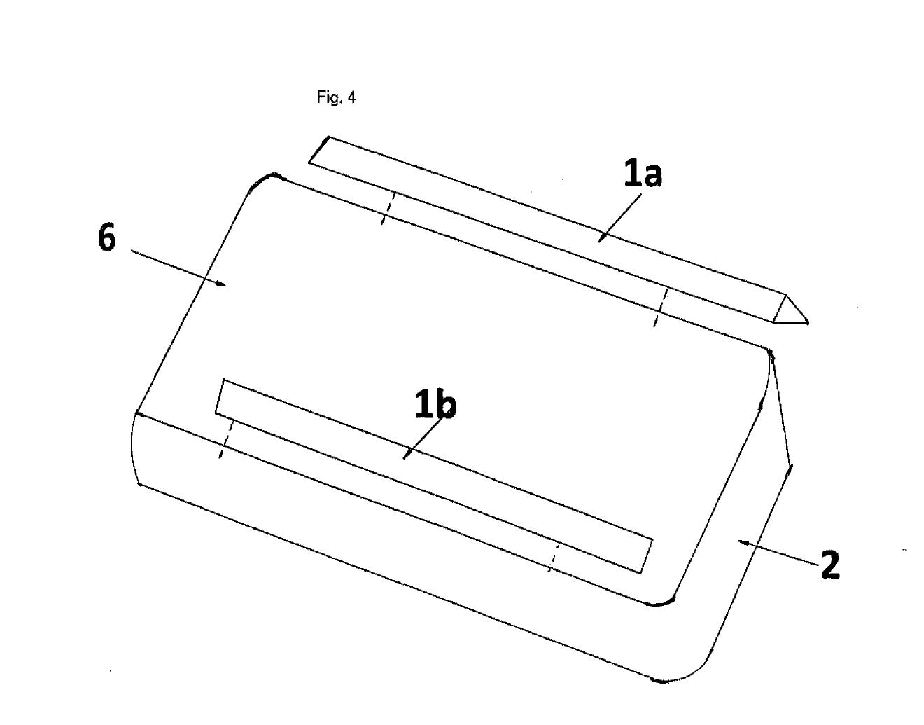

Referring to FIG. 4, according to another embodiment of the present invention, the top 4 and bottom 3 aspects may consist of geometric shapes such as side rail la illustrating a triangular geometric shaped rail and lb illustrating a squared geometric shaped rail, profiles and/or the like, which, in addition to forming a structure, make up the shape and the design of the overall cover profile 7. In this embodiment, there may be openings along one or more side aspects that open in a flat configuration. Hence different length lateral aspects may be interchanged to meet various user needs and/or restrictions. The different geometric shapes may be arranged on the lateral aspects such as cylindrical, squared or other geometric shapes for example that create various profiles and/or the like, thus changing the shape and the design of the cover aspect 6. Any or all perimeter rails may be secured to the base cover 7 or any adjacent perimeter rail aspect by means of glue, double-sided tape, velcro-like surfaces, and/or the like. The base cover aspect 7 and the side rail aspects 1 may be fixed to the desired geometric designed profiles composed of any variety of acceptable materials like with adhesives, double-sided tape, velcro-like surfaces glue and/or the like with no need for supports. The base cover aspect 7, and a number of perimeter rail aspects are secured as seen in the illustration 4 (see FIG. 1), with adhesives, velcro-like surfaces, tapes and/or the like. It should be noted that the term perimeter rail aspects refers to the illustration only and in other embodiments rail aspects may be placed anywhere on base cover aspect as per desired profiles. The cover may be transported partially or totally disassembled and assembled when delivered to the customer, thus making the transportation easier.

In general, the foregoing description is provided for exemplary and illustrative purposes; the present invention is not necessarily limited thereto. For instance, the present invention may comprise other devices added thereto without deviating from the invention since the characteristics initially claimed herein are not lost. Also, certain aspects of the model presented herein may be altered such as: materials, shape, etc. without altering what has been originally claimed herein. Rather, those skilled in the art will appreciate that these and additional modifications, as well as adaptations for particular circumstances, will fall within the scope of the invention as herein shown and described and the claims appended hereto.

1. A cover for beds comprising: a cover with a structure formed by optional perimeter rails affecting profiles and/or the like that make up the shape and the design of the cover, top, bottom, foot and left and right side perimeter rails secured onto the cover provides various combinations of profiles from various materials such as; folded fabrics, foams, plastics and/or the like, having in the optional top aspect, a raised aspects and/or the like which contains the whole top aspect, a bottom aspect, and side aspects which form collectively, the perimeter support rail aspects; perimeter support rails collectively or in some combination provide various profiles, and/or the like, that form the shape and the design of the cover; the base aspect made from a initially flat part, may conform to the surface below same, has in the top and bottom aspect of the cover various optional side rails that make up the resulting desired profile, whose shape, and design, may act as an support barrier for movement along one of more raised top, bottom, and lateral aspects about the cover; the cover is complemented by materials of foam, plastic, synthetic or organic materials and/or the like, has various walled geometrically dimensional aspects and/or like which may be removable in some embodiments.

2. The cover of claim 1, further comprising an optional top support rail aspect and/or the like that make up the perimeter rails that have flexible surfaces that may provide support and/or the like utilizing various perimeter rails such as a: top aspect, bottom aspect, base aspects, one or more side aspects and/or the like, secured to the edges of the bed cover or adjoined to adjacent perimeter or nonperimeter support aspects of the cover and/or the like.

3. The cover of claim 1, further comprising an optional bottom support rail and/or the like that make up the perimeter rails that have flexible surfaces that may provide support and/or the like utilizing various perimeter rails such as a: top aspect, bottom aspect, base aspects, one or more side aspects and/or the like, secured to the edges of the bed cover or adjoined to adjacent perimeter or nonperimeter support aspects of the cover and/or the like.

4. The cover of claim 1, further comprising lateral support rails, and/or the like that make up the perimeter rails that have flexible surfaces that may provide support and/or the like utilizing various perimeter rails such as a: top aspect, bottom aspect, base aspects, one or more side aspects and/or the like, secured to the edges of the bed cover or adjoined to adjacent perimeter or nonperimeter support aspects of the cover and/or the like.

5. The cover of claim 1, further comprising the adjustable perimeter support rails, flexible or fixed joints and/or the like to join one or more lateral side aspects.

6. The cover of claim 1, further comprising the perimeter support rails aspects, being a one-piece part from a various geometric shape options, profiles and/or the like and having flexible interfacing mounting surfaces, supports and/or the like for securing to said base cover aspect.

7. The cover of claim 1, wherein the rails and/or removable aspects are secured with glue, resin, adhesives, velcro-like surfaces, double-sided tape and/or the like or other affixing means to the base cover aspect.

8. The cover of claim 1, further comprising the perimeter support rail aspects that have joints, protrusions and/or the like to attach clamps and/or the like to secure various aspects to said base cover aspect.

9. The cover of claim 1, further comprising the top, bottom, and lateral rail aspects that may be adjusted and has flexible interfacing aspects and/or the like.

10. The cover of claim 1, further comprising the covering aspects that change the configuration of the cover, arranged on the geometric ally shaped support rail aspects, profile and/or like lateral, top and bottom aspects , secured by means of adhesives, glue, double-sided tape, velcro-like surfaces, and/or the like.

11. The cover of claim 1, further comprising the parts that may be totally disassembled and joined together by means of the perimeter support rail aspects, flexible interfacing aspects and/or the parts that may be joined and/or secured directly or indirectly by means of double sided tape, glue, adhesives, velcro-like surfaces, and/or the like.

12. The cover of claim 1, further comprising rails, flexible interfacing aspects and/or the like that may be changed and/or adjusted to reduce or increase the size of the cover.

13. The cover of claim 1, wherein the base cover may be constructed of various materials including;
foam, plastics, synthetic fibers and the like.

14. The cover of claim 1, wherein the base cover may be designed to conform or not conform to the surface to which it is placed.

15. The cover of claim 1, wherein the base cover may be designed to couple to a mattress by means of straps, a constrictable material with elastic qualities, and/or the like.

16. The cover of claim 1, wherein the base cover may be designed to fit various size mattresses such as hospital bed mattresses, infant cribs standard or customized mattresses and or the like.

17. The cover of claim 1, wherein the cover may be disassembled, transported partially and/or totally disassembled and assembled later.

18. The cover of claim 1, wherein the cover may be made from materials that can be clean and reused or made from materials that may be disposed of.
